(19) United States
(12) Patent Application Publication
(10) Pub. No.: US 2025/0101948 A1
(43) Pub. Date: Mar. 27, 2025

(54) METHODS AND MACHINES FOR HARVESTING ELECTRICITY FROM FLUID FLOWS

(71) Applicants: Dimo Georgiev Stoilov, Sofia (BG); Georgi Dimov Stoilov, Sofia (BG)

(72) Inventors: Dimo Georgiev Stoilov, Sofia (BG); Georgi Dimov Stoilov, Sofia (BG)

(21) Appl. No.: 18/684,778

(22) PCT Filed: Aug. 24, 2021
(86) PCT No.: PCT/BG2021/000022

§ 371 Date: Feb. 19, 2024

(51) Int. Cl. F03D 9/25; F03D 9/12

(52) U.S. Cl. CPC F03D 9/25; F03D 9/12; F05B 2260/87; F05B 2270/20

(57) ABSTRACT

The subject of this invention are two methods for converting the kinetic energy of fluids into electric energy, and machines for their embodiment, whereby the energy of the turbine rotor is not transferred to the generator's rotor via the shaft, directly or by a gearbox, but is transferred via: i) motor-generator (dynamotor) or ii) direct interaction between two systems of coils/windings: a) the first one being fed by electrical source for creation of a rotating magnetic field, the torque of which is added to the torque of the hub with blades because the windings are fixed to it or to its shaft; b) the second windings, designed for induction of electric energy in them, which are motionless or fixed to another hub with counter torque.

### TECHNICAL FIELD

The described invention relates to methods and apparatuses for conversion of the kinetic energy of fluids (liquids or gases) into electric energy.

Especially the described invention presents two methods for converting the kinetic energy of fluid flows (flows of water, wind, steam, gases, etc.) into electric energy and machines for their embodiment.

### BACKGROUND ART

The movements of fluids are considered as flows of liquids or gases from high pressure areas to low pressure areas. The moving mass of fluids bears kinetic energy directed towards the course of the flow.

The most known first phase in fluid kinetic energy conversion chain converts fluid mass energy into rotational mechanical energy by an apparatus, which is named “rotor” (“wind rotor”, “impeller”, “runner”, “turbine rotor”, etc.). Each rotor consists of a set of blades, fixed to a shaft directly or through a hub with or without pitch control mechanism. The forces from the fluid flow on the blades cause a torque, which rotates/turns the rotor shaft.

For greater yield of rotating mechanical energy, the rotor is placed in a shell, which channels and directs the fluid flow. The combination of these apparatuses is called a turbine (steam, hydro, gas, etc.). The notion “wind turbine” is correct for wind apparatuses that channel and/or direct the wind flow.

The known machines for conversion of the kinetic fluid energy into electric one are aggregations of a turbine (wind rotor), an electric generator, and ancillary devises. According to the type of the fluids, machines are considered as hydro aggregates, steam turbine aggregates, gas turbine aggregates, wind machines, etc.

The essence in the known methods and machines is that the shaft of the respective rotor (wind, water turbine, steam turbine, gas turbine, etc.) transfers directly or through a gearbox the rotational mechanic energy to the rotor of the electrical generator. The latter converts the rotational mechanic energy into energy of a rotating magnetic field. Then the energy of the rotating magnetic field induces electric energy in the stator of the electrical generator.

The subject of this invention are two methods for converting the kinetic energy of fluids into electric energy, and machines for their embodiment, whereby the energy of the turbine rotor is not transferred to the generator's rotor via the shaft, directly or by a gearbox, but is transferred via: i) motor-generator (dynamotor) or ii) direct interaction between two systems of coils/windings: a) the first one being fed by electrical source for creation of a rotating magnetic field, the torque of which is added to the torque of the hub with blades because the windings are fixed to it or to its shaft; b) the second windings, designed for induction of electric energy in them, which are motionless or fixed to another hub with counter torque.

As it is disclosed further the target of our invention is to increase the operational performance and safety of the fluid machines.

### DISCLOSURE OF INVENTION

The disclosed methods are inseparably combined with apparatuses through which they can be applied. For convenience, but without belittling their generality, we reveal them by means of the group of wind machines, because this group has significant technological problems arising from the non-stationarity of the primary energy source, the high peripheral velocity of the wind blades, etc.

The disclosed first method implies the following sequence of energy conversions from primary energy of a fluid flow, e.g. the wind, to electrical energy.

The first conversion is similar to the known ones: hitting the blade surface the moving air mass reflects and a part of its kinetic energy converts to a force that creates a torque, which strives to turn/drive/spin the wind rotor.

The second conversion is different. While with known methods the torque converts the linear kinetic energy of the wind into rotating mechanic energy of the wind rotor, which is transferred by the shaft to the rotor of the generator (directly or via a gear box), then with the disclosed method the torque is transferred to a stator of a motor-generator (dynamotor), fixed to the blades' hub or to the shaft of the wind rotor/actuator.

If an electrical source feeds this motor, the armature produces own torque, which is capable to turn the rotor of the motor, nevermind whether the wind rotor/actuator stands still or moves under the action of wind¹. Normally the feeding of the motor starts when the power of the wind torque becomes bigger than the idle run load of the dynamotor. Then the torque of the wind blades gathers the torque of the source of electricity. The sum of the two torques is transferred to the rotor of the motor and as a result it rotates for useful work. ¹ Strictly speaking electrical feeding and magnetic field inducing are separate energy conversions, but for simplicity we consider them in the scope of the described second conversion

Shortly, a portion of the wind primary energy is converted to rotating mechanic energy of the rotor of the electrical motor when the power of the blades' torque becomes bigger than the idle run load/reaction of the rotor of the motor.

The third conversion is inherent to motor-generators (dynamotors). It converts rotational mechanic energy of the rotor of the electrical motor into energy of the rotating magnetic field of the rotor of the electrical generator, which can be the same as the motor's rotor or another one, fixed to the common shaft.

The forth conversion is the conventional induction of electric energy when the rotating magnetic field of the rotor of the generator crosses the windings of the stator.

The functionality of an embodiment of the disclosed method is governed by a complex control of conversional apparatuses and processes: the hub's position against wind direction (yaw control), the blade's angle of attack (means of pitch control), the motor and generator speed and magnetic fields control, as well as control of the released electrical energy. The methods and apparatuses for such governments are subject of other inventions.

The usual goal of the combined control is the stable production of maximum electric energy. This is achieved by regulation of the transmitted energy in each of conversional stages: from kinetic wind to combined (kinetic-potential) mechanic, from mechanic to electromagnetic, from electromagnetic to mechanic/mass rotational, from mass rotational to magnetic rotational and from magnetic rotational to electric.

In other words, the government is a continual dynamic process for balancing the outer actions with the useful results and its aim is achieved by control of the balance between input and output energy for every conversional apparatus and process in the energy exchange chain, mostly by forecasting the wind characteristics and adequate regulation of the controlled parameters.

In case of an ideal instantaneous balance in the whole energy conversional and transferring chain, the wind rotor/actuator may remain stationary. Actually volatile fluctuations in wind velocity, direction and air density could not be balanced in each instant but a mean balance is achieved during different time intervals. As a result, the wind rotor/actuator swings around balance positions. Such rotor behavior is quite different than the fast rotations as in the known methods and machines for wind (and generally for fluid flow) energy utilization. This gives grounds that names “mover”, “propulsor”, “pusher”, “actuator”, “driver” are more suitable than “wind rotor” with regard to the disclosed machines.

In case of insufficient wind velocity, the wind rotor/actuator stays blocked or swings freely and no electric feeding is applied to the motor for avoiding the rotation of its rotor because the generated energy would be smaller than the reaction of the dynamotor, which would result to more consumed than produced electricity. Even more, if the generator is switched on to the network it can change its mode and become a motor, which can result to opposite rotation of the motor and the wind actuator.

Other control (utilization) objectives are also feasible, e.g. constant electrical output, participation in load-frequency control etc. In such cases individual approaches are projected, e.g. aggregation with storage apparatuses, flexible loads, etc.

The second disclosed method consists of simplified chain of conversions of the primary wind energy into electrical one with regard to the described first method. Here the third conversion (from the rotating torque of the motor to mechanical rotation of the aggregated rotor) is missing. So the method consists of only three conversions.

The first conversion is the same as in the first method: the moving air mass reflects on the surface of the blades and converts a part of its kinetic energy into a torque.

The second conversion is similar but not the same as the second conversion in the first method: the primary torque created by blades is transferred directly to first windings, fixed to a hub, which are fed with electricity from a source and create secondary torque so that the sum of two torques is transferred to the created by the windings rotating magnetic field.

The third conversion here is similar but not the same as the forth one in the first disclosed method, namely: created at the previous conversion rotating magnetic field induces electricity directly in second windings, which may be fixed stationary or turn in the opposite direction if they are fixed to a second hub, which transfers counter torque.

The usual objective of an embodiment of the disclosed second method is also the stable production of maximum electric energy, but the control capabilities are reduced. The control process seems simplified, but the lack of rotating inertial mass makes functionality less stable. The improvement of stability requires an advanced control.

The disclosed machines for conversion of wind energy into electrical one present examples for implementation of the disclosed methods. They are described in the part for Best Mode for Carrying Out the Invention.

### BRIEF DESCRIPTION OF DRAWINGS

The disclosed methods are applicable to all type of fluid flow energy conversion machines but for simplicity we illustrate their application only to both classes of wind electric machines: with horizontal as well with vertical axis.

The attached figures illustrate the main parts but not the details of machines through which the disclosed methods could be embodied. The brakes and other auxiliary parts are not indicated for simplicity.

FIG. 1 depicts vertical plane section cut through the tower axis and the common horizontal axis of the wind end electrical rotors of an embodiment of the first method in the class of horizontal axis wind machines.

FIG. 2 depicts vertical plane section cut through the machine axis and the diameter of the two systems of blades staying in diameter position of an embodiment of the first method in the class of vertical axis wind machines.

FIG. 3 depicts vertical plane section cut through the tower axis and the common horizontal axis of the wind rotor and electrical windings of an embodiment of the second method in the class of horizontal axis wind machines.

FIG. 4. depicts vertical plane section cut through the machine axis and the diameter of two systems of blades staying in diameter position of an embodiment of the second method in the class of vertical axis wind machines.

### BEST MODE FOR CARRYING OUT THE INVENTION

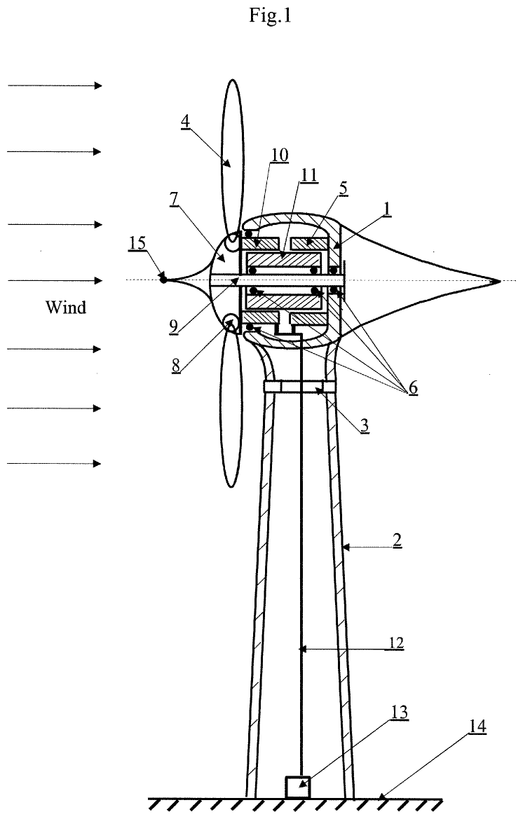

As a first embodiment for the first method we present an example from the class of horizontal axis wind machines, illustrated in FIG. 1.

Similar to the known machines the nacelle 1 of the disclosed one is disposed on a tower 2 by means of a yaw drive 3 mechanism to align the set of blades 4 for rotation in the plane perpendicular to the wind direction. The stator 5 of the electricity generator is the only part which is fixed to the corps of the nacelle. The rest of the main parts are rotatable by means of bearing systems 6.

The hub 7 of the wind rotor/actuator fastens the blades 4 by means of the pitch control mechanism 8 and joins them to the shaft 9 of the wind rotor/actuator.

Unlike the known machines the shaft 9 of the wind rotor/actuator does not turn the rotor of the generator, directly or via gearbox. This shaft 9 supports the bearing of the wind rotor/actuator, but does not transfer the torque. For conversion of the torque into rotation and for transfer of the kinetic energy are applied the apparatuses described below.

The primary torque of the wind rotor/actuator is transferred to a stator 10 of a motor by fixing it to the hub 7. Fed from an electrical source, the motor creates a secondary torque, so that the sum of the both torques (from wind rotor and from motor) acts onto the rotor of the motor 11. This rotor is aggregated to the rotor of an electrical generator. Various constructions may embody such a common rotor according to the type of electrical current, the source and geometry of the magnetic flux, etc. They are subject to other inventions.

For simplicity we generalize this diversity and illustrate an aggregation of motor and generator rotor like one part of the machine under number 11. By this clearer understanding is achieved on how the primary wind rotor's torque is transferred to the stator 10 and is added to the secondary torque created by an electrical source in the motor-generator (dynamotor). In this way their sum rotates the rotor 11, whereby the wind rotor/actuator may not rotate. Normally the wind rotor/actuator simply swings around a balance position.

The electrical supply of the motor, the current collector of the generator, the power and the control cables are illustrated collectively as number 12.

The control block 13 is disposed in a panel on the ground into the tower 2, where the electrical equipment for connection to the network and the rest of electrical devices are combined as well. It processes the signals from wind sensors 15 and the rest of control parameters in order to provide stable and efficient functioning of the machine.

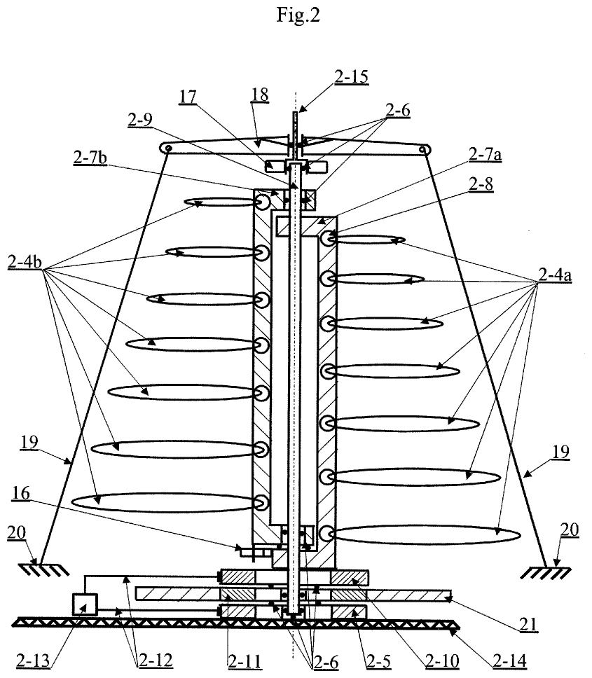

As a second embodiment for the first method we present an example from the class of vertical axis wind machines, illustrated in FIG. 2.

Similar to the known machines, the disclosed one is disposed on a base 2-14, to which only the stator 2-5 of the electricity generator is fixed. The rest of the main parts are rotatable by means of bearing systems 2-6.

Unlike the known machines the rotor/actuator of the disclosed machines does not rotate, but swings around balancing positions, bearing upon the vertical support. In other words, there are no returning blades (these that move against the wind) and there is no need to compensate their counter torque. On the contrary, the sets of blades are designed for creation of two maximum possible counter torques from the two halves of wind flow passing through both imaginary half planes (separated by the vertical axis) perpendicular to the wind direction.

For illustration of this principle in FIG. 2 two hubs 2-7a and 2-7b are drawn each of which fastens its set of blades 2-4a and 2-4b stacked on top of each other by means of related pitch control mechanism 2-8². They get the wind energy from both sides of the vertical axis and swing around it, born by the bottom and upper bearings 2-6. The number and the size of the blades depends on the desired capacity of the machine. ² For clarity of the figure we do not show by arrow signs all of pitch control mechanisms because their placement is evident.

Both blade sets provide opposite torques, that can be used efficiently by means of two dynamotors. For simplicity we illustrate an embodiment at which the stator 2-10 of the motor is fixed to the hub 2-7a, and the other hub 2-7b transfers its torque to the stator by ratchet 16 when the torque is directed in right direction. In this way the negative swing torque is not going to brake the motor.

The shaft 2-9 does not turn the rotor of the generator, neither directly nor via a gearbox.

When the stator 2-10 of the motor is fed with electricity it creates secondary rotating torque, and the sum of the primary torque (from both hubs) and the secondary torque is transferred to the rotor of the motor 2-11. This rotor 2-11 is aggregated with the rotor of the electric generator so for simplicity we illustrate the aggregation of the motor and the generator rotors like one part of the machine under the same number 2-11. Here we present an embodiment with parallel disks and axial magnetic field/flux. Equally a dynamotor with a drum rotor and a radial magnetic field could be used.

The reaction of the rotor acts contrary to the sum of torques resulted by the forces from both blade sets that push the stator. At accomplished balancing between torque of the wind actuator with the resistance of the rotor, the stator simply swings around a balance position.

The electrical supply of the motor, the current collector of the generator, the power and the control cables are illustrated altogether under number 2-12.

The control block 2-13 is disposed in a panel on the ground, where the electrical equipment for connection to the network and the rest of electrical devices are combined as well. It processes the signals from wind sensors 2-15 and the rest of control parameters in order to provide stable and efficient functioning of the machine.

The known vertical axis machines do not need yaw mechanism, but the disclosed machines consist of two sets of blades designed for a combination of lift and drag forces. The optimal position of the sets is when the imaginary plane taken through the centers of forces on the blades' surfaces is perpendicular to the wind direction. The direction of both sets of blades towards the optimal position is controlled by the devise 17 in interaction with the system for balance control. In addition to the control of the amplitude of the hubs' swing it can be combined with the stall control and/or with a mechanism for safety during risky weather conditions.

The upper part of the machine is supported by a cross support 18, which is guyed by steel cables 19 to the footings 20.

For increasing the inertial mass and smoothing of oscillations a flywheel 21 is fixed to the rotor of the dynamotor.

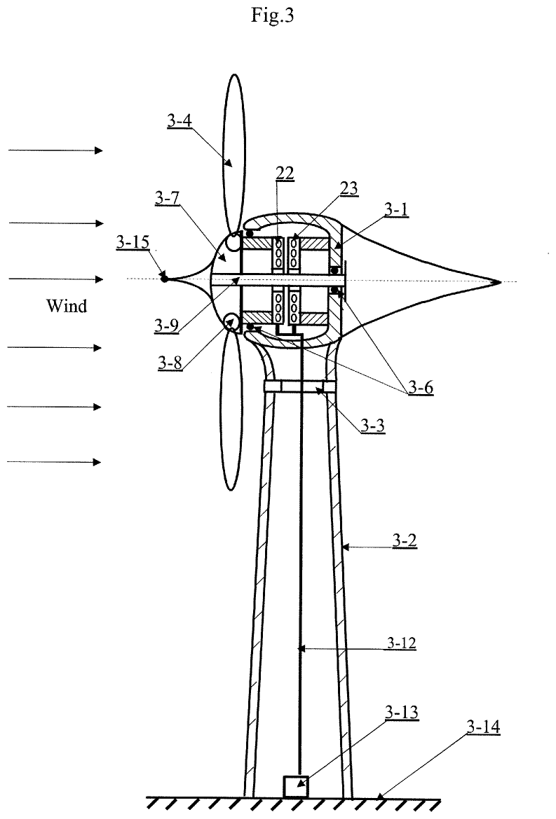

As a first embodiment for the second method we present an example from the class of horizontal axis wind machines, illustrated in FIG. 3.

In short, this is the same machine illustrated in FIG. 1 and described above with two differences: missing the rotor 11 of the dynamotor and modifications of the both stators 5 and 10 for achievement of a direct efficient mutual induction between two systems of windings (winding 22 for creation of the rotating magnetic field supplied by an electrical source and winding 23 in which the useful electrical energy is induced) by means of special medium with high magnetic conductivity.

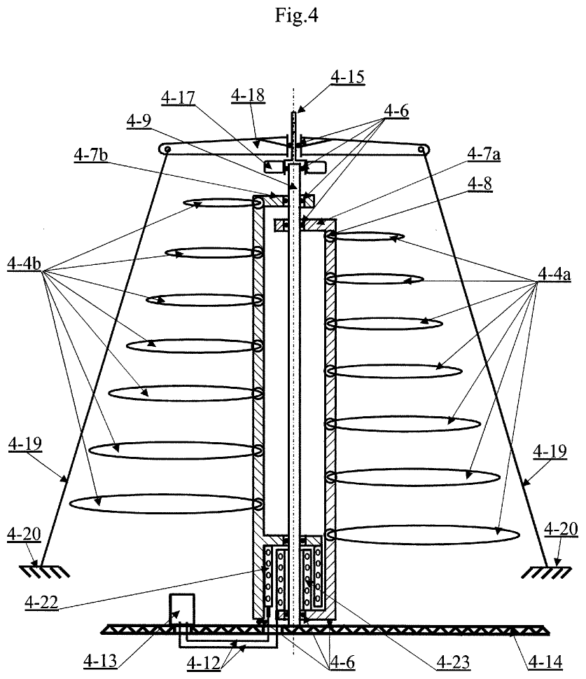

As a second embodiment for the second method we present an example from the class of vertical axis wind machines, illustrated in FIG. 4. It differs from the machine in FIG. 2 by the lack of rotor 2-11. Naturally the lack of the rotor 2-11 makes not applicable the flywheel 21 from FIG. 2.

Instead of stators 2-5 and 2-10, two windings 4-22 and 4-23 are installed, respectively for creation of the rotating magnetic field by an electrical source and for induction of the useful electrical energy by means of special medium with high magnetic conductivity.

In addition to the inherent to the methods' differences some construction variations are presented as well. Here are illustrated two drum windings with radial magnetic field instead of the disc ones. Each hub has independent bearing around the vertical shaft 4-9 and on the base 4-14. Because of this the way of transfer of the primary torque is changed. The winding 4-22 is fixed to the hub 4-7b and embraces directly the primary torque from it. The winding 4-23 is fixed to the hub 4-7a and embraces directly the primary torque from it.

Finally, we would like to emphasize the essential difference between the known machines and the disclosed machines for implementation of the second method.

At known machines the electric energy is induced in the stator of the generator due to the action of the rotating magnetic field of the electrical rotor when it is rotated by the wind rotor (or by a turbine in general).

In the disclosed machines the electric energy is induced in the windings 23 due to direct action of the rotating magnetic field created by the windings 22, fed by an electrical source, without necessity of an electrical rotor, whereupon the primary torque of the rotor (or respective sets of blades) is transferred to the rotating magnetic field always when the obtained by the fluid flux (wind) force is bigger than the load.

### INDUSTRIAL APPLICABILITY

The description and the drawings depict some simplified machines for clear explanation of the disclosed methods. The simplified illustration and description do not reduce the relevance of the disclosure due to predominance of the inherent advantages over the deficiencies.

The disclosed methods and machines utilize the torque created by a fluid flow by means of a dynamotor or via a direct mutual electromagnetic induction between two systems of windings with a high magnetic conductivity medium between them. In both cases the respective rotor/actuator swings around a balance position but do not turn fast as is the case with the known machines. This provides several advantages: reduction of the centrifugal loadings, reduction of the dangers for birds, reduction of the noise etc. As a result, the machines with equal to the known ones' capacity could be with relieved blades, and accordingly, for design of a more powerful machine with more harvested energy, sets of more and bigger blades could be utilized.

The increase of the losses in the machine due to the implementation of a dynamotor instead of direct rotation of the electric rotor by the shaft is a disadvantage of the first method. The scale of this losses is smaller than the losses in the gearbox and in the other convertors of the known machines, and because such appliances are not necessary for the disclosed machines the balance sheet is in favor of suggested ones.

The internal losses are lower in the machines implementing the second method and this is another advantage but the lack of mechanic inertia due to the lack of electrical rotor is a weakness that results in reduced stability in the electricity production process. The compensation of this shortcoming requires advanced control systems.

In the disclosed machines that realize the first method the dynamotor could be of DC or AC type, with permanent magnets or with excitation magnetic system of conventional poles, coils and direct current source. AC synchronous or induction machines can be implemented; both mono and poly-phase. Both drum dynamotors (with radial flux) and disks dynamotors (with axial flux) can be used as well.

The approaches, methods and means for control of the disclosed machines depend on the chosen combination for DC or for AC current; the type of motor-generators; the type of the magnetic flux. Their descriptions are subjects to other inventions, and that is why here they are just mentioned as auxiliary means.

Like the other industrial novelties, the disclosed methods and machines will pass through the phases of model and experimental investigations, creation of prototypes, trials, and upgrades. The specific constructive elements will be chosen according to technological and economic criteria during the phase of product design, which is beyond the aim of this description.

### REFERENCES CITED

### I. Patent Documents

I.1. WO2018232472, Stoilov G.D. and Stoilov D.G., Wind Electric Machine Without Stators, 2018. Available at: https://patentscope2.wipo.int/search/en/detail.jsf:jsessionid=272CAFAFD51796E51BD26ECA0B73C580?docId=WO2018232472&recNum=45&office-&queryString=&prevFilter=&sortOption=Pub+Date+Desc&maxRec=73057870;

### II. Non-Patent Documents

II.1. Tony Burton, David Sharpe, Nick Jenkins, Ervin Bossanyi, Wind Energy Handbook, WILEY, 2001;
II.2. Thomas Ackermann ed., Wind Power in Power Systems, John Wiley & Son, 2005, ISBN 0-470-85508-8;
II.3. David A. Spera, ed. Wind Turbine Technology—Fundamental Concepts of Wind Turbine Engineering, second edition, ASME, 2009;
II.4. Wei Tong ed., Wind Power Generation and Wind Turbine Design, WIT Press, 2010, ISBN: 978-1-84564-205-1;
II.5. A.R. Jha, Wind Turbine Technology, CRC Press, 2011;
II.6. Peter Jamieson, Innovation in Wind Turbine Design, Wiley, 2011;
II.7. Muhammad Mahmood Aslam Bhutta, Nasir Hayat, Ahmed Uzair Farooq, Zain Ali, Sh. Rehan Jamil, Zahid Hussain, Vertical axis wind turbine—A review of various configurations and design techniques, Renewable and Sustainable Energy Reviews 16, 2012;
II.8. M.R. Islam, S. Mekhilef, R. Saidur, Progress and Recent Trends of Wind Energy Technology, ELSEVIER, RSER, 2013;
II.9. Erich Hau, Wind Turbines Fundamentals, Technologies, Application, Economics, Springer, Third ed. 2000, 2006, 2013;
II.10. M. Ragheb, Wind Energy Converters Concepts, 2014;
II.11. Victor Lyatkher, Wind Power—Turbine Design, Selection, and Optimization, Scrivener Publishing LLC, 2014, ISBN 978-1-118-72092-9.

1. A method for conversion of the kinetic energy of a fluid flow into electrical one, characterized by:
creation of a primary torque by a set of blades fixed to one or more collective hubs at one or more rotors/actuators,
transferring the primary torque to a stator of a motor-generator (dynamotor), fixed to a hub or the shaft of a rotor,
feeding the motor-generator from a source of electricity and creation of a secondary torque,
turning the rotor of the motor-generator by the sum of primary and secondary torques, where sad rotor simultaneously can be a rotor of the electrical generator or can be coupled to the rotor of the electrical generator for transfer of the rotation to it,
induction of electricity (electromotive force) in the stator of an electrical generator by the rotation of sad generator's rotor, where sad stator may be motionless or turned in the opposite direction by another hub, that transfers a counter torque,
dynamic regulations of controlled parameters for balance of the input and output energy at every conversional apparatus and process in the energy exchange chain, aiming a stable production of maximum electric energy and resulting in a soft swing of the blade set around a balance position, instead of the fast turning of the blades as is the case with the known methods.

2. A machine for conversion of the kinetic energy of a fluid flow into electrical one according to the method in claim 1, which comprises:
fluid flow rotor/actuator, combining one or more sets of blades, conjoint through one or more hubs with or without pitch control mechanisms, for creation and transfer of the primary torque from the fluid flow,
motor-generator (dynamotor), that includes motor's stator, generator's stator, a common rotor or two rotors (of the motor and of the generator) coupled on a common shaft, as well as ancillary parts,
own or external electrical source for feeding of the motor and creation of a secondary torque, which is added to the primary torque of the blades,
base, which as the case may be a tower, or a pole, or a column, etc., a yaw drive mechanism, bearings, supporting and auxiliary elements for accomplishment and functioning of the machine.
sensors, transmitters and receivers, control block and other devices for provision of a stable and efficient functioning,
and which machine is characterized by the following peculiarities:
the motor's stator is fixed to the hub or to the shaft of the fluid flow rotor/actuator for acceptation the primary torque from the blades and adding it to the secondary torque, created when the motor is fed by an electric source,
the rotor of the motor adopts and transfers both torques to the rotor of the generator,
the sum of both torques rotates the rotor of the electrical generator inducing electricity in the stator of the electrical generator,
the generator's stator can be motionless or fixed to a second hub adopting a counter torque from it.

3. A machine for convertion of the kinetic energy of a fluid flow into electrical one according to claim 2 additionally comprising a fly wheel fixed to the rotor of the motor-generator.

4. A method for conversion of the kinetic energy of a fluid flow into electrical one, characterized by:
creation of a primary torque by a set of blades at one or more rotors/actuators,
transferring the primary torque to a collective hub and to first windings, fixed to this hub,
feeding the first windings by a source of electricity and creation of rotational magnetic field, which carry the sum of the primary and the secondary torque, created by sad source of electricity,
direct induction of electricity in second windings, which may be motionless or turned in opposite direction by the torque of another hub.
dynamic regulations of controlled parameters for balance the input and output energy at every conversional apparatus and process throughout the energy exchange chain, aiming a stable production of maximum electric energy and resulting in a soft swing of the blade set around a balance position, instead of the fast turning of blades as is the case with the known methods.

5. A machine for convertion of the kinetic energy of a fluid flow into electrical one according to the method in claim 4, which comprises the following parts:
fluid flow rotor/actuator, combining one or more sets of blades, conjoint through one or more hubs with or without pitch control mechanisms, for creation and transfer of the primary torque from the fluid flow,
fixed to a hub first windings for creation of a rotational magnetic field, which accumulates the blades' torque with the torque from an electrical source,
own or external electrical source for feeding of the first windings,
motionless or fixed to another hub second windings, where the electricity (electromotive force) is generated due to the rotational magnetic field, created by the first windings,
special medium with high magnetic conductivity between the two windings,
base, which as the case may be a tower, or a pole, or a column, etc.; a yaw drive mechanism; bearings; supporting and auxiliary elements for accomplishment and functioning of the machine.
sensors, transmitters and receivers, control block and other devices for provision of a stable and efficient functioning.
